(19) United States
(12) Patent Application Publication
(10) Pub. No.: US 2009/0241050 A1
(43) Pub. Date: Sep. 24, 2009

(54) SYSTEM FOR ENTERPRISE SERVICE FLOWS

(76) Inventors: Jyh-Huei Kuo, Taipei City (TW); Yuan-Chun Francis Li, Taipei City (TW)

Correspondence Address: SINORICA, LLC, 2275 Research Blvd., Suite 500, ROCKVILLE, MD, 20850, US

(21) Appl. No.: 12/164,244

(22) Filed: Jun. 30, 2008

(30) Foreign Application Priority Data
Mar. 20, 2008 (TW) 097109949

(51) Int. Cl. G06F 3/048

(52) U.S. Cl. 715/771

(57) ABSTRACT

The invention discloses a system for enterprise service flows. The system comprises a database, a user interface and a processing module. The database records a plurality of enterprise resources and a plurality of service flow programs, in addition, the service flow programs correlate with at least one of the plurality of enterprise resources. The user interface is used for a user to select at least one enterprise resource; the processing module further comprises a flow management unit. The processing module performs correlative link based on the selected enterprise resource, the flow management unit of the processing module arranges the combination of the plurality of enterprise resources in correspondence to the plurality of service flow programs. Consequently, an enterprise is able to dynamically increase its entire competitiveness based on its service flows required.

### BACKGROUND OF THE INVENTION

(a) Field of the Invention

The present invention relates to a system for enterprise service flows, and more particularly, to a flow management technology that enables a plurality of service flow programs in correspondence with relevant enterprise resources to be executed.

(b) Description of the Prior Art

Enterprise Resource Planning (ERP) system is a substantial information management system for an organization; however, with the development of information technology and seeing that an enterprise has evolved a complex environment with complicated data flows, the ERP system has been designed more complicated than ever. Consequently, the amendment and adjustment of ERP system become much more difficult. For example, ERP software with services-based platform for an enterprise needs to be adjusted to respond to internal and/or external environmental changes of an enterprise from time to time, but the truth is that such information system is unable to cooperate with the changes in an organization in a timely fashion. The ERP design generally sets up diverse steps for operations based on different enterprise resources, in addition, various functions and display screens are usually linked together for operations, therefore, when any organization change occurs, it's necessary for most of the corresponding computer programs to be reprogrammed, rectified or adjusted to be in harmony with other computer programs and/or systems. This is a task for an enterprise and may cause a minus in enterprise's competitiveness.

In view of the foregoing demerits, the invention is disclosed herein to solve the aforementioned problems and reduce enterprise cost during the duration that the system conducts reprogramming, rectification or adjustment.

### SUMMARY OF THE INVENTION

The primary objective of the present invention that has been made to solve the aforementioned problems is providing a system for enterprise service flows. The system comprises a database, a user interface and a processing module. The database is used to record a plurality of enterprise resources and a plurality of service flow programs; those service flow programs correlate with at least one of the plurality of enterprise resources. The user interface is used for a user to select at least one enterprise resource. The processing module further comprises a flow management unit, in addition, performs correlative link based on the selected enterprise resource; the combination of the plurality of enterprise resources in correspondence to the plurality of service flow programs are performed by the flow management unit of the processing module. Consequently, an enterprise is able to dynamically improve its entire competitiveness based on its service flows required.

A detailed description is shown in the following embodiments with reference to the accompanying drawings.

### BRIEF DESCRIPTION OF THE DRAWINGS

FIG. 1 is a block view showing a system for enterprise service flows according to the present invention.

FIGS. 2A to 2D are schematic views showing preferred embodiments of the system for enterprise service flows of the present invention.

FIG. 3 is a flowchart showing steps according to an enterprise flow control method of the present invention.

### DETAILED DESCRIPTION OF THE PREFERRED EMBODIMENTS

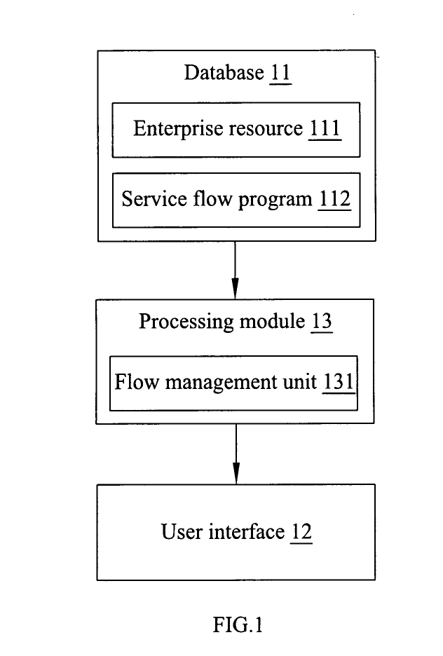

With reference to FIG. 1, the system comprises a database 11, a user interface 12 and a processing module 13. The processing module 13 further comprises a flow management unit 131. The database 11 is to record a plurality of enterprise resources 111 and a plurality of service flow programs 112; the plurality of service flow programs 112 correlate with at least one of the plurality of enterprise resources 111. The user interface 12 is used for a user to select at least one of the plurality of enterprise resources 111, such as Personnel Dept., General Administration Dept., Finance Dept., Engineering Dept. or Quality Control Dept., etc.

The processing module 13 is correlatively linked to one of the plurality of enterprise resources 111 that is selected by a user, in addition, the combination of the plurality of enterprise resources 111 in correspondence to the plurality of service flow programs 112 are performed by the flow management unit 131 of the processing module 13 to stylize steps for dynamic operations of one single enterprise service. Consequently, an enterprise is able to dynamically improve its entire competitiveness based on its service flows required.

The user interface 12 is preferably a keyboard, a touch pad or a mouse, etc. The processing module 13 is preferably a microprocessor. The database 11 is stored in a hard disk, a FLASH memory or a storage memory, etc.

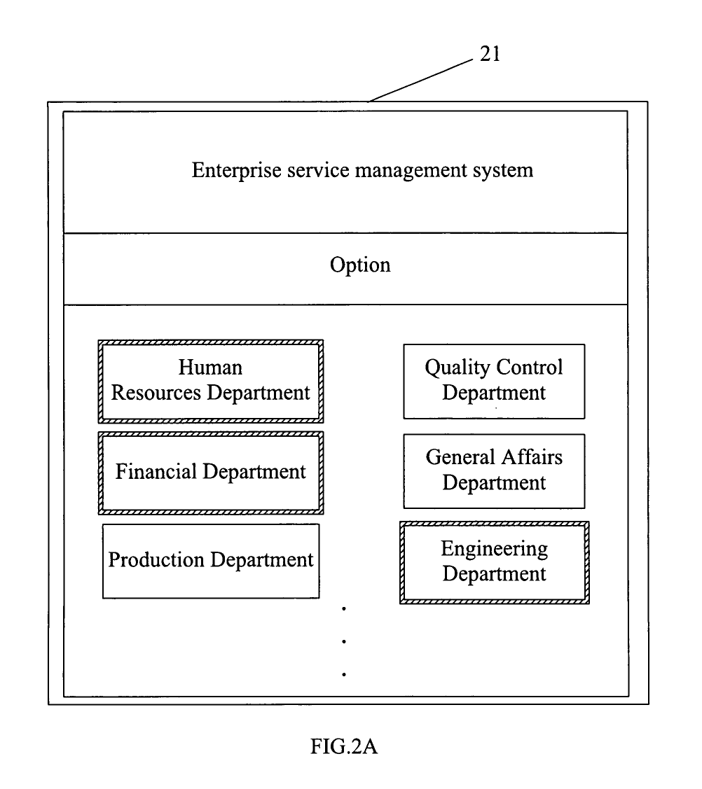

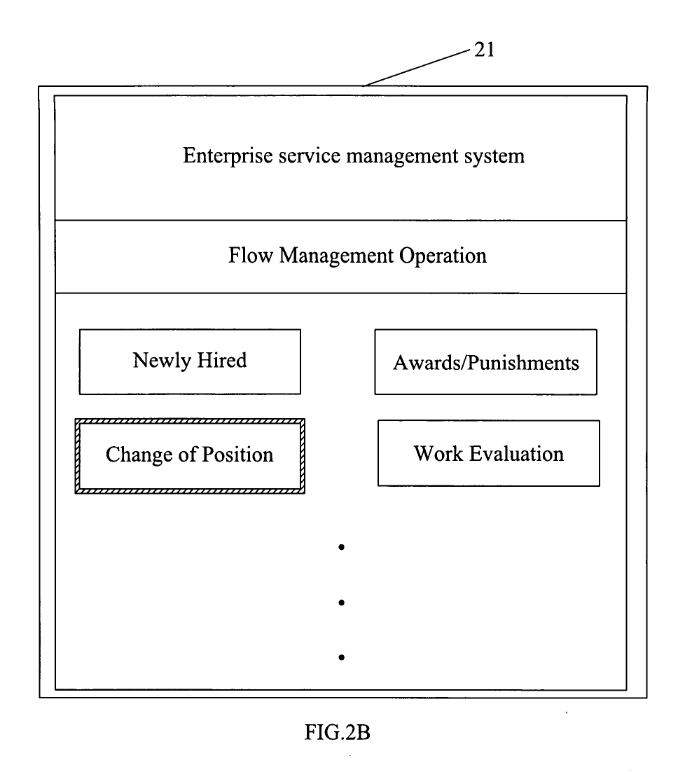

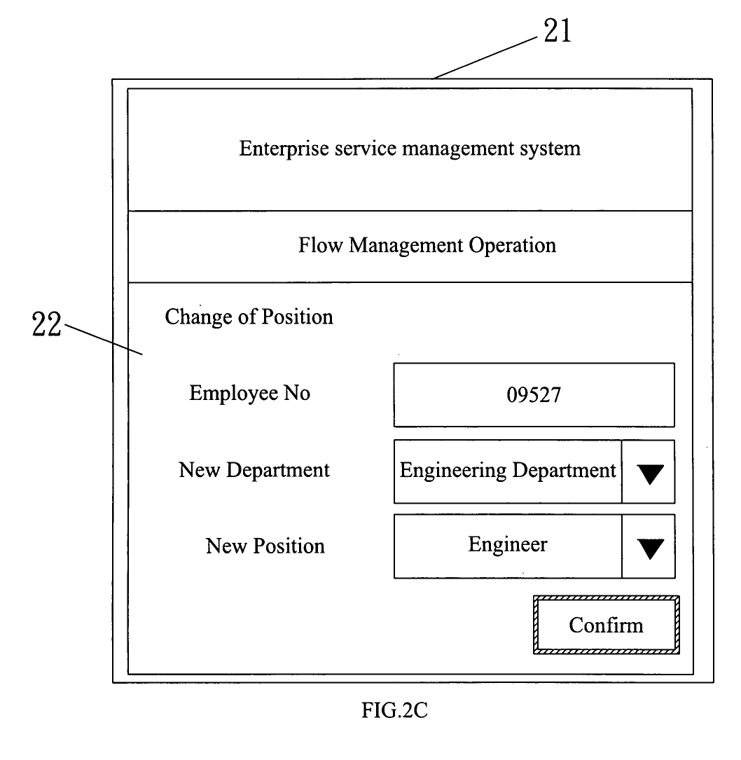

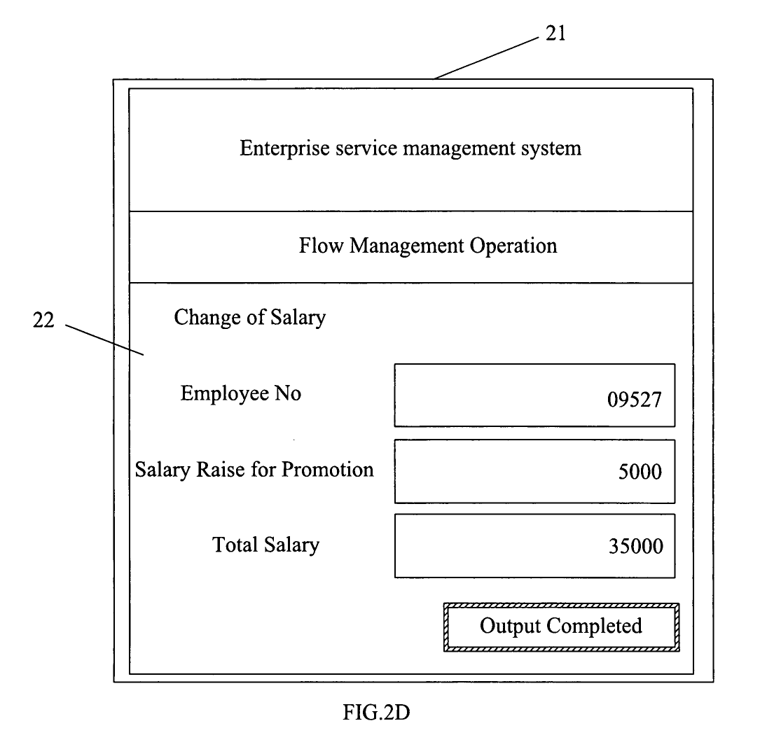

FIGS. 2A to 2D are preferred embodiments of the invention by taking an example of staff promotion in Engineering Dept. Referring to FIG. 2A, when a user selects one of the enterprise resources 111, such as “Personnel Dept.”, “Finance Dept.” or “Engineering Dept” though the user interface 12, the processing module 13 then retrieves one of the service flow programs 112 from the database 11 that is correlative with the selected enterprise resource 111. The database 11 is stored in a HARD DISK, a FLASH memory or a storage memory, etc. Moreover, the flow management unit 131 of the processing module 13 executes stylized steps of the service flow program 112 in relation to the enterprise resource 111 selected, such as Personnel Dept., Finance Dept. or Engineering Dept., etc. for dynamically operating a single service.

Referring to FIG. 2B, a display screen 21 subsequently shows various selection items, such as recruiting, personnel change, bonus-penalty or assessment, etc. When the user selects the item of “personnel change”, the processing module 13 then executes service flow programs in connection with Personnel Dept. and enables a form template 22 to be completed by the user for personnel change. Referring to FIG. 2C, the user completes the data on the form template 22, comprising a personnel ID, employed dept. (e.g. Engineering Dept.) and a new position (e.g. engineer), and then, presses “OK” to complete the process of personnel promotion in Engineering Dept.

Referring to FIG. 2D, the processing module 13 then executes relevant service flow program in connection with Finance Dept. and displays a form template 22 for the user to complete a personnel ID, personal allowance (e.g. NT$5,000) and adjusted salary amount (e.g. NT$35,000) and press “Completed” button, consequently, the salary changing flow of a staff in Engineering Dept. due to promotion is completed. After both the flow of staff promotion in Engineering Dept. and the flow of salary adjustment are completed, the processing module 13 executes next service flow program required and sends relevant data to Engineering Dept. as the basis of the adjustment of job description. Other flows in an enterprise can be operated following similar processes. The plurality of the enterprise resources 111 are respectively corresponding to the plurality of the service flow programs, so that an enterprise is able to quickly adjust its systems and operations depending on their required dynamic service flows and improve its entire competitiveness.

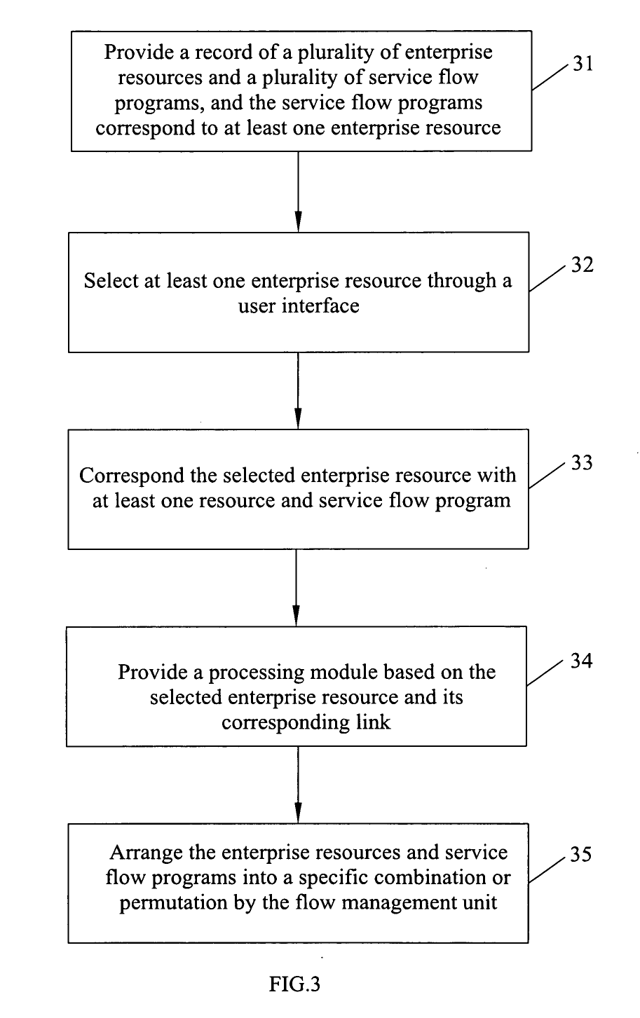

With reference to FIG. 3, an enterprise flow control method of the invention comprises the following steps as:
Step 31 : recording a plurality of enterprise resources and a plurality of service flow programs; wherein the plurality of service flow programs correlate with at least one of the plurality of enterprise resources;
Step 32: enabling a user to select at least one enterprise resource through a user interface;
Step 33: correlating the selected enterprise resource with at least one service flow program for the enterprise resource;
Step 34: performing correlative link based on the selected enterprise resource; and
Step 35: arrangeing the combination of the plural enterprise resources in correspondence to the plurality of service flow programs.

What has been described above is the preferred embodiment of the present invention only, and it is not intended to limit the scope of the present invention. Various equivalent changes and alternatives to the present invention can be made to the elements of the present invention without departing from the spirit and scope of this present invention. Accordingly, all such equivalent changes and alternatives should be included within the scope of the appended claims.

It will be appreciated and understood by those skilled in the art from the above detailed description that the present invention can achieve the foregoing objective indeed, and the application for a patent is duly filed accordingly.

I claim:

1. A system for enterprise service flows, comprising:
a database, recording a plurality of enterprise resources and a plurality of service flow programs, wherein the plurality of service flow programs correlate with at least one of the plurality of enterprise resources;
a user interface, for a user to select at least one enterprise resource; and
a processing module, comprising a flow management unit, correlating the selected enterprise resource with a correspondent flow program, and enabling a flow management unit to arrange the combination of the plurality of enterprise resources in correspondence to the plurality of service flow programs.

2. The system for enterprise service flows as described in claim 1, wherein the user interface is a keyboard, a touch pad or a mouse.

3. The system for enterprise service flows as described in claim 1, wherein the database is stored in a HARD DISK, a FLASH memory or a storage memory.

4. The system for enterprise service flows as described in claim 1, wherein the processing module is a microprocessor.

5. An enterprise flow control method, comprising the following steps:
recording a plurality of enterprise resources and a plurality of service flow programs, wherein the plurality of service flow programs correlate with at least one of the plurality of enterprise resources;
enabling a user to select at least one enterprise resource through a user interface;
correlating the selected enterprise resource with at least one service flow program for the enterprise resource;
performing correlative link based on the selected enterprise resource; and
arranging the combination of the plurality of enterprise resources in correspondence to the plurality of service flow programs.
